(19) United States
(12) Patent Application Publication
(10) Pub. No.: US 2012/0272143 A1
(43) Pub. Date: Oct. 25, 2012

(54) System and Method for Audience-Vote-Based Copyediting

(76) Inventor: John Gillick, New York, NY (US)

(21) Appl. No.: 13/092,868

(22) Filed: Apr. 22, 2011

(51) Int. Cl. G06F 17/24

(52) U.S. Cl. 715/256

(57) ABSTRACT

A system and method for audience participation in vote-based copyediting. Online content readers may indicate certain content errors to the online publisher, such as highlighting an identified typographical error. These errors may be sent to an administrator who can take corrective action. Reports may include a prioritized list (e.g., prioritized by the number of votes each particular error received), or the reports may be contingent on a threshold number of votes. Users may enter suggestions, which may also be provided in the reports, and/or suggestions by be automatically integrated, if allowed by the online publisher (e.g., after a certain number of votes is reached).

### BACKGROUND

The Information Age has exponentially accelerated as the boundaries of the Internet and

World Wide Web have expanded across the globe. Users have come to expect Internet-based publication of news, events, and other content in near real-time. Not only are news articles published daily, but in some venues, those articles are updated several times during the course of a single day. In addition to the rapid publishing schedules of large media outlets, the proliferation of free blogging software and free blog hosting has given anyone with a computer the ability to self-publish. Mirco-blogs such at Twitter® have further advanced the speed in which thoughts may be published to the public and/or a specific audience. Mainstream media outlets, e.g., those who still maintain legacy distribution networks, e.g., broadcast networks, newspapers, etc., have augmented those services to include the new web-publishing, web-logs (blogs), and even micro-blogs. Events of particular interest are “live blogged,” which essentially includes a frequently updated contemporaneous blog or micro-blog account of events. This may be especially true for events open to the public, but where cameras are not allowed, e.g., courtrooms, FDA decision panels, etc.

The sheer volume of text generated by these new outlets renders it almost impossible to proofread everything published. While the main content (e.g., articles) may still receive a traditional level of fact-checking and proofreading, much of the faster paced publications (e.g., blog entries, micro-blog entries, forum posts, etc.) go mostly unchecked before publication, or at least unchecked by someone other than the author. Thus, the proliferation of typographical errors and common spelling/grammar mistakes has grown even faster than the content itself.

Content sharing and edit integration may already exist in the art. For example, in a basic form, an author may e-mail content to an editor, who may return a corrected copy for publication. In a more advanced version of this, the author may email content to several people, a peer, an editor, a proofer, and a friend, who may each return a different set of corrections, which may be integrated into a single corrected copy for publication. However, currently, this is limited to a small group of people, prior to publication. It slows down publication cycles, and has inherent limits on the number of people who can participate. There is no way for audience participation in editing, and/or automatic correction.

Currently, the closest technology to allowing this are comments and flags. When an author posts a blog entry, invariably “helpful” readers point out every typographical mistake by leaving a comment in any available reader comment section. As an editing tool, it is inefficient. Additionally, it clutters the substantive comments section (e.g., readers' opinions), with edit notes that were not required for readers to understand the original message. Flags may include a variety of configurations, but often times leave no public indication that someone activated the flag (e.g., as compared to a comment visible by all readers), and often times take automatic corrective action. For example, forum and posting sites (e.g., craigslist.org) include a “report abuse” flag, such that when a sufficient number of users click it, that post is automatically deleted. Alternatively, an administrator may review abuse reports, and make a decision about whether a post should be deleted. Regardless of the automatic or manual nature of the moderation, this community policing is focused exclusively on identifying posts that should never have been made, and should therefore be deleted. There is no functionality for correcting or even identifying legitimate content that requires slight revision.

Example embodiments of the present invention provide systems and methods for automatic and manual content editing, based on audience submitted voting.

### SUMMARY

Example embodiments of the present invention provide online content editing tools to the audience of the online content. As an example, a blogger may post an entry that contains one or more typographical errors. Readers of the blog may use audience-based copyediting tools to identify errors. Alternatively or additionally, the readers may enter a suggestion. Either or both of these entries may then be sent to the author and/or automatically incorporated (e.g., after a sufficient number of votes are entered. The tools may be provided within browser software, within the website's encoding, as a plug-in, as a local application, or any other configuration. Publishers may incentivize use by rewarding readers' entries in any number of ways. Publishers may moderate suggestions, and may be given suggestion/error reports, which may be prioritized according to any number of configurable criteria.

### BRIEF DESCRIPTION OF THE DRAWINGS

FIG. 1 illustrates an example method, according to one example embodiment of the present invention.

FIGS. 2A to 2E illustrate example user interfaces, according to other example embodiments of the present invention.

FIG. 3 illustrates an example backend system, according to another example embodiment of the present invention.

### DETAILED DESCRIPTION

Example embodiments of the present invention provide systems and methods for automatic and manual content editing, based on audience submitted voting. A tool may be provided that allows a user to indicate a suggested edit. Tools may include those for large and small areas of text, images, sounds, links, metadata, functionality, etc. Essentially, a tool may be implemented to modify any portion of any content accessible by a plurality of users. For example, at a specific level, a single word edit may be possible. A user may identify a typographical error such as a sentence that reads: “Your right, typos are hard to eliminate.” The user may be given a series of tools for indicating an edit is required. For example, a first tool may highlight an area of suggestion (e.g., “Your”). A second tool may provide edit options, such as a text entry box for replacement text (e.g., “You're”). This entry may be uploaded to the server hosting the original content (or any other data repository), where one or more algorithms may use the feedback for corrective measures or report generation.

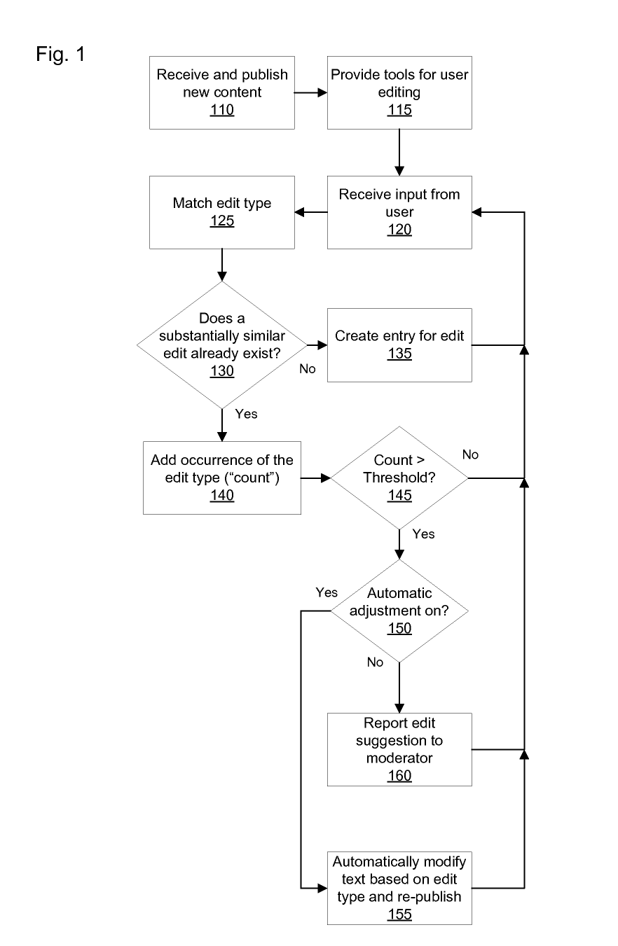

FIG. 1 illustrates an example method, according to one example embodiment of the present invention. At 110, the example method may receive and publish new content. This may be performed in any number of ways, using any number of technologies known in the art. This content may be published for consumption by an audience (e.g., the public at large, or a smaller audience). One example may be a blog, where users navigate to the blog using a web-browser (e.g., Internet Explore, Chrome, smart phone explorers, etc.). In this context, many functions, tools, and options are already presented to the user. For example, the web-browser may have a menu bar (e.g., File, Edit, Options, etc . . . ), back/forward/home/refresh buttons, links to other stories, advertising sections and applications, print buttons, email forward buttons, and/or any number of other functions. Further, fly-out option menus may be provided, such as right-clicking a work, area, or highlighted phrase. The fly-out menu may include any number of functions unique to that menu or available in other areas (e.g. the menu bar).

Along with those tools already available in online publishing sites, an example embodiment of the present invention may provide tools for user editing at 115. This tool may be configured to receive user input at 120. The user input may include one or more edits, which may be matched against other users' input at 125. If a similar edit does not already exist at 130, the example embodiment may create a new entry for that suggestion at 135, and return to waiting for more input from other users at 120. If the entry already existed, or in some embodiments is substantially similar, if not identical, then the example embodiment may, at 140, add an occurrence of the edit type (e.g., increment a counter for this entry). In one example embodiment, the backend algorithm may be configured to check, e.g. at 145, if the occurrence count is above a certain threshold. If not, the example embodiment may return to receiving user input from the editing tools at 120. If the count does exceed the threshold, the algorithm may be configured to perform automatic adjustments at 150, such that the backend system may automatically modify the text based on the edit type exceeding the count threshold and republish the corrected text at 155. Alternatively, the example method may merely report suggestions to a moderator at 160, and return to receiving user input.

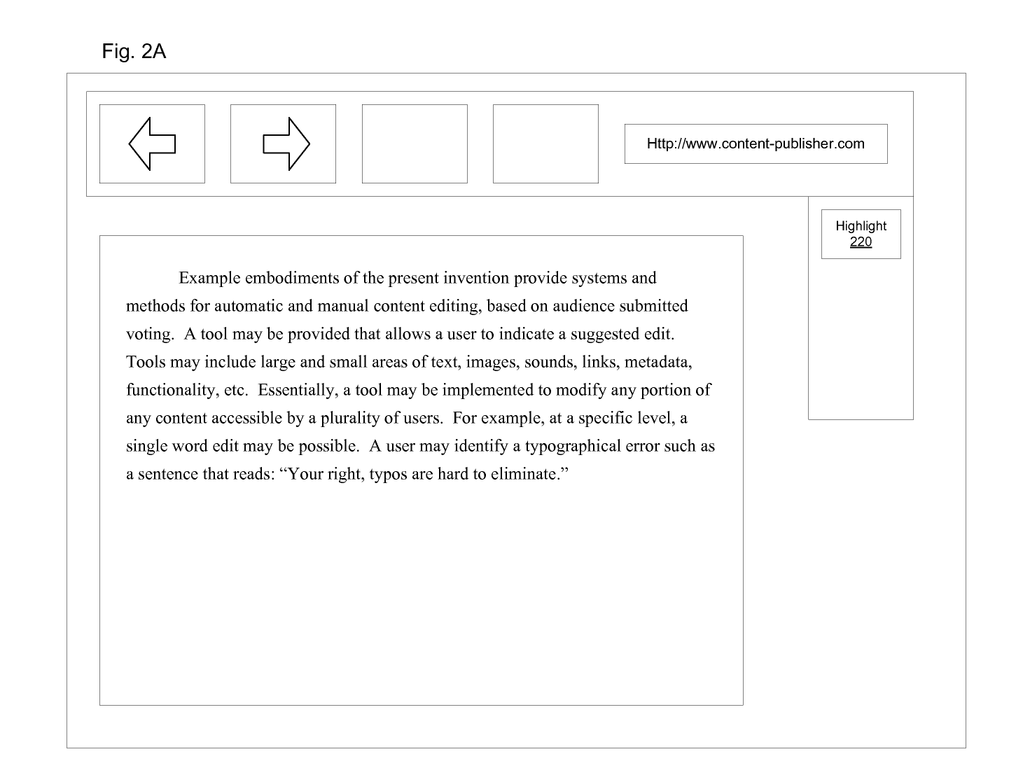

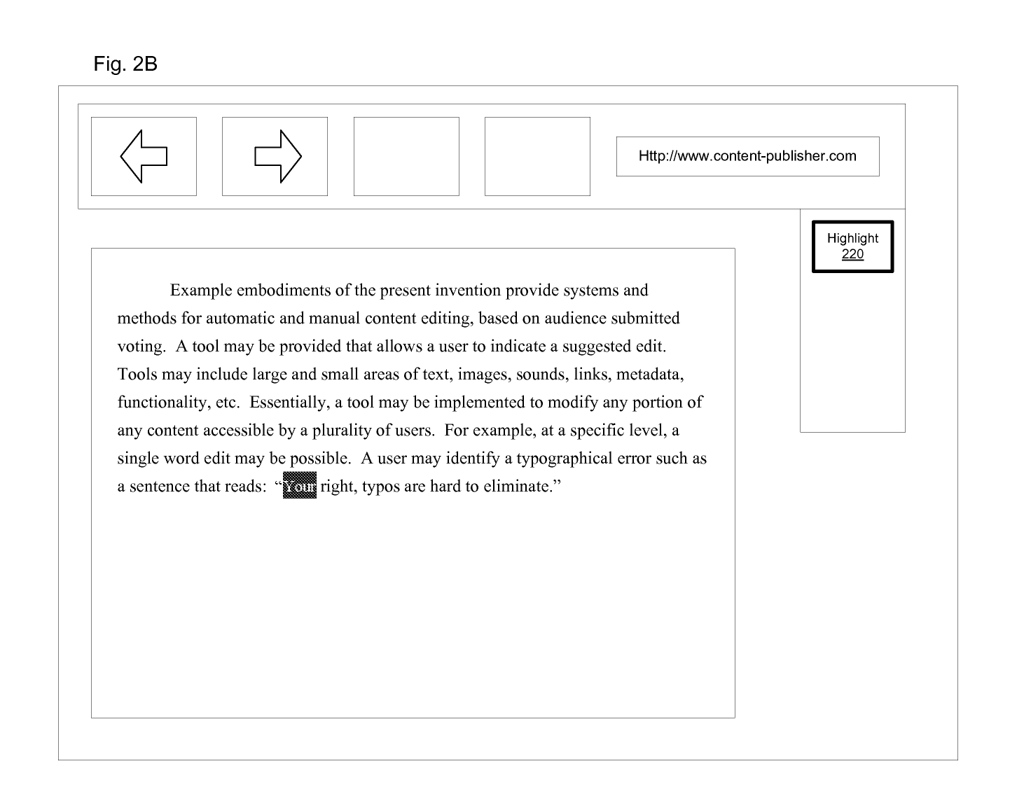

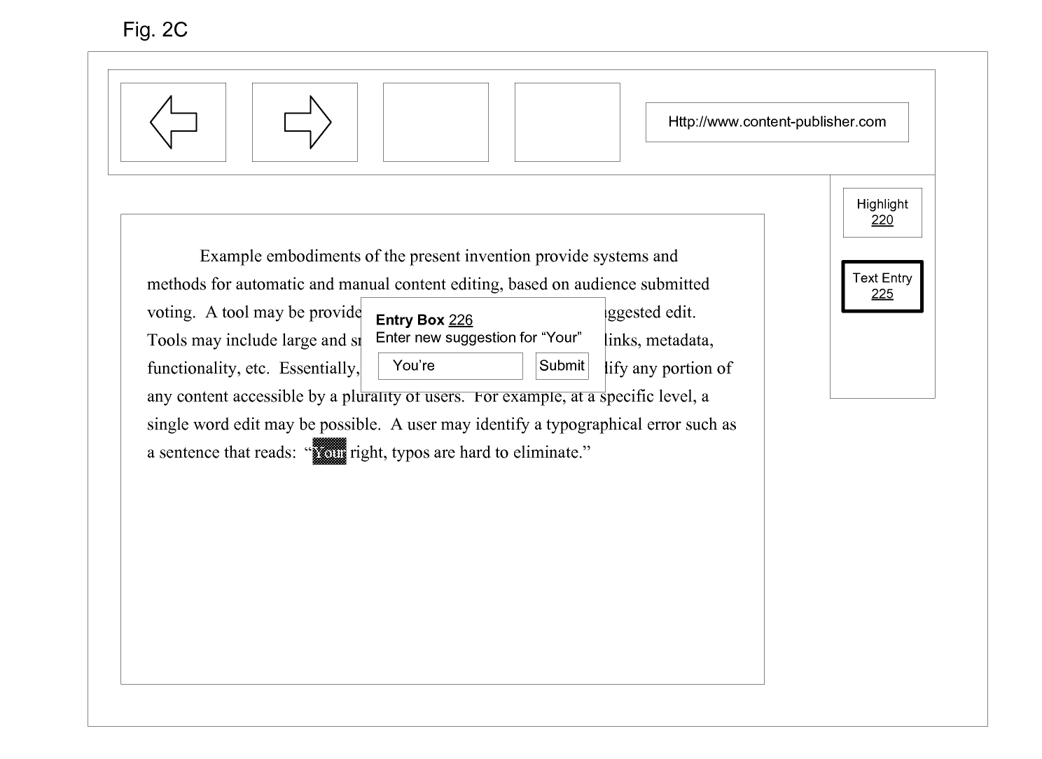

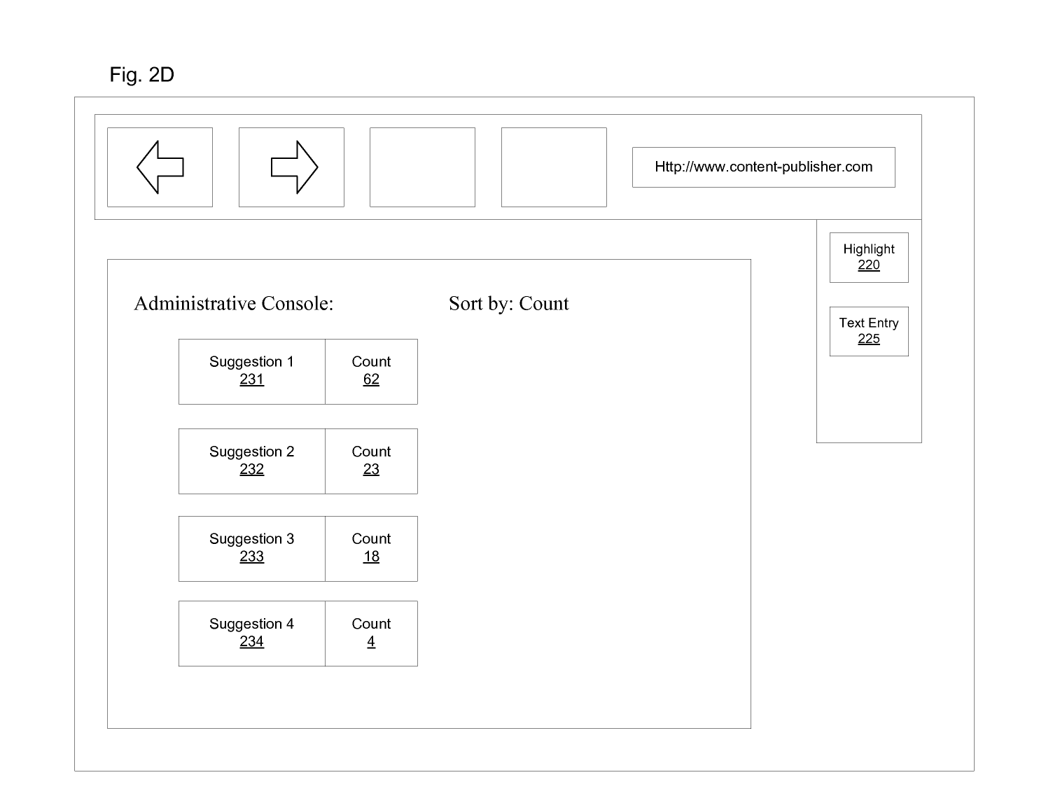

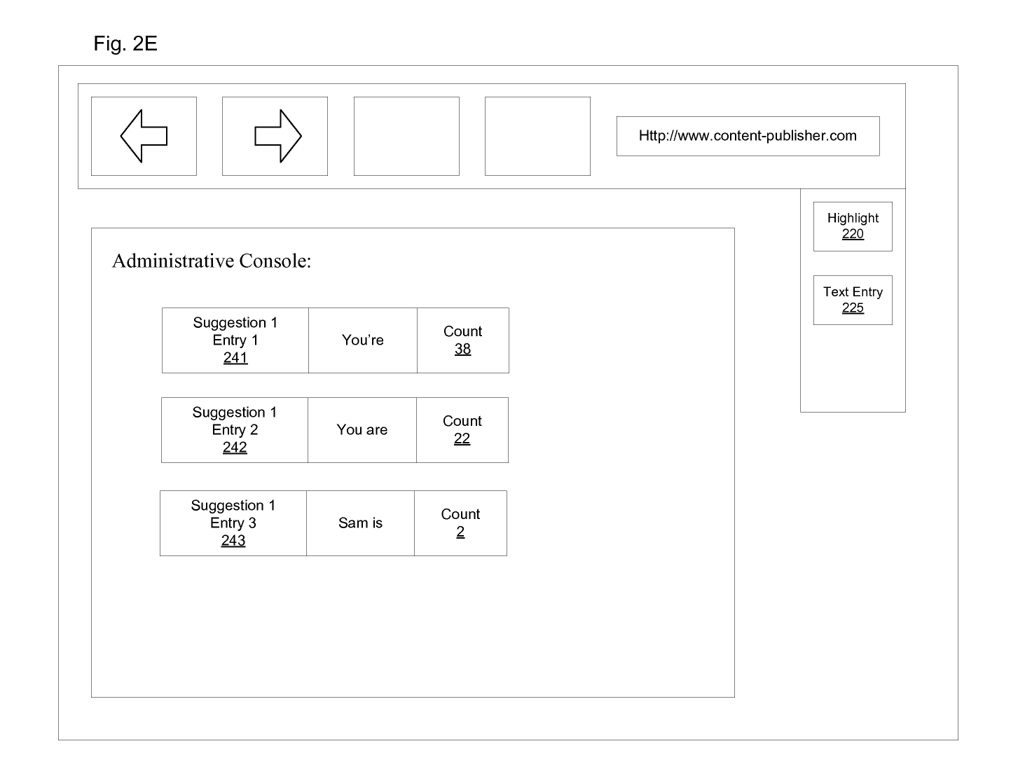

FIG. 2A illustrates an example user interface, including one example tool set, according to one example embodiment of the present invention. There may be a highlight function 220 for highlighting text. This may be a selection tool by itself or it may leverage a selection tool already present in the user interface application. For example, a user may select text (e.g., “Your”) with a standard text selection tool that is part of a third-part web-browser user interface, and this click function 220 to activate editing functions for that highlighted text. FIG. 2B illustrates an example user interface with this highlight function 220 activated and the text “Your” highlighted. FIG. 2C illustrates the example user interface with a second function available, text entry 225. This function may have been available, presented but unavailable, or hidden prior to activation of highlight function 220. Regardless, in FIG. 2C the text entry function 225 is activated, which may correspond to any number of text entry functions. One example is illustrated by entry box 226. In this example, entry box 226 may be a hover-over style box, as is common with web-based code languages (e.g., Java). As illustrated, the box prompts the user for a new suggestion for the highlighted text, provides an entry box, and provides a submit button. The user may type in their suggestion (e.g., “You're”) and hit the submit button. The example systems and methods may then accept user input from that same user in different places, and additional input from other users. To ensure integrity, the system may prevent or discourage multiple entries of the same type by the same user, as is customary for vote-based web applications.

FIG. 2D illustrates an example administrative console, according to one example embodiment of the present invention. This console may be accessible in the same third-party web browser, a different interface, or a specifically designed proprietary application. Here, a moderator or editor of the published content site (e.g., as illustrated in FIG. 2A) may log into an administrative consol and see various reports and results of the user input. This could be configured in any number of ways, and FIG. 2D illustrates a list of suggestions 231 to 234. Next to each suggestion is a count, where the example interface may indicate the number of times that suggestion was received, and/or the number of times a substantially similar suggestion was received. This may correspond to the suggestions target, e.g., the highlighted original text. For example, suggestion 1 (231) may correspond to the word “Your” from FIG. 2A, and 62 users may have reported a problem with this word. Suggestion 2 (232) may correspond to another word in that article, or a word/phrase from a different text set. The administrator can see an ordered list of user editing input, sort that input in any number of ways, and select the various entries for moderation.

For example, FIG. 2E illustrates one example user interface where suggestion 1 (231) has been selected. In this sub-screen, the administrator may now see what suggestions were provided by the users to flagged the word “Your.” Here, 38 recommended alteration to “You're,” 22 recommended alteration to “You are,” and 2 recommended alteration to “Sam is.” While “Sam” may in fact be related to the text, often the system will contain several worthless entries, especially when the audience is the greater anonymous public. Ordering by count may help eliminate all or most of these outlying suggestions. In other example embodiments, the system may autocorrect the text (e.g., as discussed in FIG. 1) after a certain period of time (e.g., with the suggestion having the greatest frequency), or upon a certain count threshold being achieved by a particular suggestion. In more controlled settings, suggestions may be presented in administrative reports (e.g., as in FIG. 2E) and edits may only be issued once approved. For example, as illustrated in FIG. 2E, the most common correction of the “Your” may be the contraction “You're,” which is the most commonly used term. However, contractions are generally not used by more formal publications, and an administrator may choose Entry 2 (242) as a matter of publication specific policy. In addition to a count, entries may be given tools for modifying, accepting, deleting, ignoring, etc.

Whether set to auto-correct or be moderated, a text entry that is edited by an example embodiment of the system may become locked, may have its suggestion list purged, and/or may continue to accept edits. For example, an administrator may set the count threshold low, which causes an edit based on initial feedback (e.g., “Your” to “You're”), but upon additional feedback by additional users, a suggestion of “You are” may obtain a higher count, and again auto-edit the target text with this suggestion. Other grammatical issues are also viable targets of the example embodiments. For example, in a sentence “This morning Jeff published an article this morning” clearly has a redundant phrase “this morning,” but either instance could be removed. This may pose an issue for an autocorrect configuration, where roughly half the suggestions are to delete the first occurrence and half are to delete the second occurrence. Thus, additional tools may be provided for determining “substantially similar” suggestions, based on proximity, textual similarity between the target text of the two or more suggestions, and/or any number of other statistical matching functions for identifying related but different suggestions. Additional tools may be provided, such as multiple disjointed text highlights as the suggestion target, and/or suggestion entries other than replacement text (e.g., a suggestion entry the user may select to indicate “delete one”). Other suggestion entries may include “sentence fragment,” “sentence ends in a preposition,” “passive voice sentence,” etc. These errors may be easily identified by users, but may not have readily discernable replacement suggestions. However, even in situations like this, replacement text edits may be accepted, as the moderator may want editing suggestions to choose from.

Any number of other grammatical errors, typos, misspellings, or erroneous word usages may be addressed by example embodiments of the present invention. Further, system administrators may construct block-out or ignoring rules for any number of situations. For example, an editor may autocorrect user suggestions of “you're” as “you are,” or may allow for contractions. An editor may ignore indications of sentences ending with prepositions, as a general policy of allowing this sentence construct as acceptable. The editor may maintain a list of word suggestions that are never accepted, especially when auto-correct functions are used, such as vulgarity or other offensive language. Example embodiments may come preloaded with these customization tools (e.g., a preloaded list of offensive words), that may be used and/or modified by administrators of a particular implementation.

Reports may be sent to one or more administrators via a web based console, a local application, an email message, or any other kind of communication platform (e.g., SMS, MMS, IM, etc.). Each of these may also include a function for accepting and/or modifying the suggestion. For example, an editor may receive an email similar to the administrative console of FIG. 2D, 2E, or a combination of the two (e.g., a bulleted list of suggestions, with suggestion entries branching off of each suggestion). Each entry may have an accept link to an encoded address, such that selecting the link causes the edit to take effect in the publication system (e.g., such techniques to confirm ownership of an email address are known in the art). As another example, the editor may receive an SMS text message on their phone. The text message may include the target text, and may pull the surrounding text (e.g., the sentence containing the target text) for context. The editor may then accept by reply SMS message, and/or including an alternative edit. For example, the editor my receive a SMS message that says—“Your right, typos . . . ” (1) You're, (2) You are, (3) Sam is—allowing the editor to reply with the number of the selected suggestion entry, which may cause the backend system to made the selected modification. Alternatively, the user may reply with “You are not” to have the target text modified outside the user suggestions to “You are not right, typos . . . ” In this context, the SMS message may include an option of “(4) other,” and the editor's reply may be “4 You are not.”

Other tools are also possible for more diverse editing abilities with limited-interface technology. For example, in the above situation, the user may send a reply SMS message of “(4) +6 You are correct,” which may indicate the system should replace the target text “Your” plus an additional six characters (e.g., “ right”) with the provided phrase “You are correct,” for an adjusted phrase of “You are correct, typos . . . ” special symbols and editing flags are also possible to facilitate these function. However, as SMS only communication devices become rarer, in favor of smart phones, mobile interfaces may be feature rich with expansive functions regardless of the interface used.

Example embodiments of the present invention may also include incentive programs. For example, a publisher may provide compensation (e.g., monetary or discounted premium content) for system users. A publisher could give a raffle entry to every accepted suggestion for a raffle prize. A publisher could pay a small reward to all members who flagged text that was later changed, all members who provided the suggestion (or substantially similar suggestion) that was eventually accepted, the member who first identified text that was later changed, and/or the first member who provided the suggestion that was eventually accepted. Obviously, the smaller the reward pool (e.g., raffle winner or first person) the greater the reward could be to the recipient(s), while the greater the reward pool size (e.g., small prize to all users who provide productive flag edits) the greater the number of compensated users.

Audience users of the system may be allowed to participate anonymously without registering for an account. Alternatively or concurrently, users may be allowed to register for an account, which may allow their rewards, contributions, and performance to be monitored. This may facilitate the monetization/reward process, and may help weight prioritization of error reports and/or automatic edit integration. For example, a user profile may track how many edit suggestions that user has entered, which were later identified (e.g., by an administrator or by audience voting) as non-responsive and/or abusive. This user's future suggestions may be discounted (e.g., given a percent of a vote as compared to the average user's vote). Additionally, users with a higher percentage of adopted suggestions may have a higher weight, acknowledging the probability that their future suggestions may also be correct. These users may be ranked, rewarded directly or indirectly for their superior contributions. For example, a user with a high correction rate may have their suggestion weighted with some vote multiple (e.g., three, as in three times the impact of the average and/or new user). This user may also have their reward multiplied by the same or similar factor (e.g., if an adopted suggestion causes a raffle entry to be issued to each user with that suggestion, this user may receive three entries, or if ten cents is paid out to each user with that suggestion, this user may receive thirty cents). Reward multipliers may be greater or less than the weight multiplier, which may be configured on a site by site basis.

Suggestions may be presented to the audience at large. For example, after entering a suggestion, a user may be presented a list of other suggestions (or a list of the more probable suggestions). The user may then be given any number of input options. For example, the user may be able to indicate each suggestion the user believes is also correct, and/or each suggestion the user believes is equivalent (e.g., a contraction and the uncontracted phrase). Users may be given options to indicate suggestions are reasonable but incorrect (e.g., the author omitted the word “affect” and the suggestion is “effect”), and/or completely inappropriate (e.g., “practical joke” entries such as “Sam was here”). This may provide full or fractional user rewards, and may further assist in weighting the error report prioritized presentation, and/or auto-integration features. Further, the list of automatically blocked or discounted entries may be automatically or manually adjusted based on the votes of inappropriate suggestions.

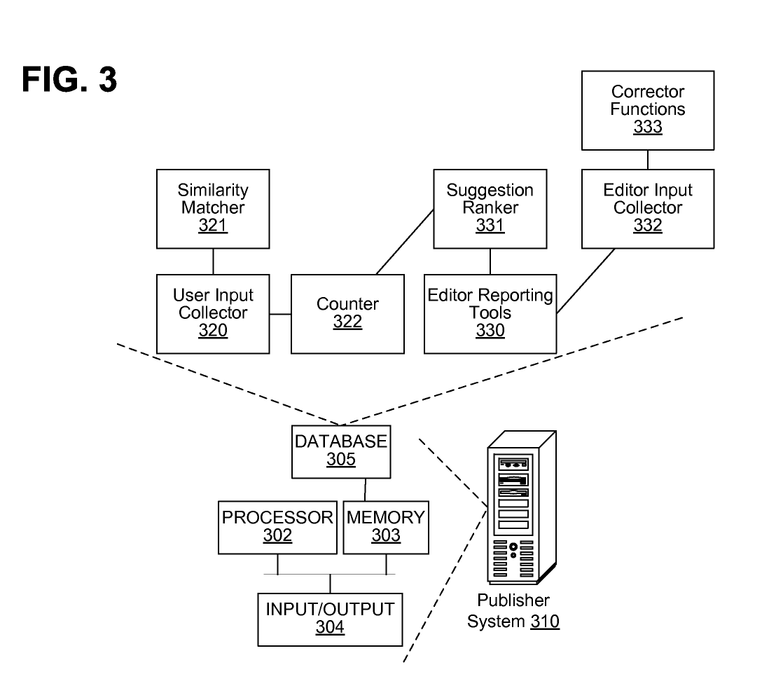

FIG. 3 illustrates an example system according to one example embodiment of the present invention. Publisher system 310 may include one or more server computer systems. This may be one server, a set of local servers, or a set of geographically diverse servers. Each server may include an electronic computer processor 302, one or more sets of memory 303, including database repositories 305, and various input and output devices 304. These too may be local or distributed to several computers and/or locations. Database 305 may include data comprising the various software components of the other example embodiments of the present invention.

For example, database 305 may include a user input collector 320 for collecting suggestion and/or edit inputs from one or more user devices providing user-entry tools, according to example embodiments of the present invention. Database 305 may include a similarity matcher 321 and a counter 322 to keep track of suggestion counts, and/or similar suggestion counts. Results may be stored in database 305, and provided to an editor/administrator via editor reporting tools 330. The editor reporting tools 330 may include a suggestion ranker 331 (e.g., with access to counter 322). An editor input collector 332 may accept editor input from the reporting tools, e.g., accept, reject, modify, etc. Input collected by 332 may initiate correction functions in the corrector function set 333, which may modify content according to the administrator or auto accepted edit suggestions.

Any suitable technology may be used to implement embodiments of the present invention, such as general purpose computers. One or more system servers may operate hardware and/or software modules to facilitate the inventive processes and procedures of the present application, and constitute one or more example embodiments of the present invention. Further, one or more servers may include a computer readable storage medium, with instructions to cause a processor, to execute a set of steps according to one or more example embodiments of the present invention.

Further, example embodiments of the present invention are directed to one or more processors, which may be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination. The one or more processors may be embodied in a server or user terminal or combination thereof. The user terminal may be embodied, for example, a desktop, laptop, hand-held device, Personal Digital Assistant (PDA), television set-top Internet appliance, mobile telephone, smart phone, etc., or as a combination of one or more thereof. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. Non-transitory storage medium is mean to include all storage mediums except transitory propagation signals. The instructions may be configured to be executed by a processor which, when executing the series of computer instructions, performs or facilitates the performance of all or part of the disclosed methods and procedures.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

1. A method for flag-based user editing, comprising:
receiving, with an electronic processor, text from a publisher user;
publishing, with the electronic processor, the text over a network accessible by a plurality of users;
providing tools for marking suggested edits to each user;
receiving input from each user including suggested edits;
compiling the suggested edits; and either:
(1) automatically integrating an edit into the text conditioned on a plurality of similar suggested edits being greater than a threshold; or
(2) presenting the suggested edits to an administrator, receiving a selection, and automatically integrating the selection into the text.

2. The method of claim 1, wherein the method performs (1).

3. The method of claim 1, wherein the method performs (2).

4. The method of claim 1, wherein the compiling the suggested edits includes determining a count for each suggestion indicating a number of users who marked the respective suggested edit.

5. The method of claim 4, wherein the presenting includes ordering the suggested edits according to their respective counts.

6. A system for flag-based user editing, comprising:
an electronic processor configured to:
receive text from a publisher user;
publish the text over a network accessible by a plurality of users;
provide tools for marking suggested edits to each user;
receive input from each user including suggested edits;
compile the suggested edits; and either:
(1) automatically integrate an edit into the text conditioned on a plurality of similar suggested edits being greater than a threshold; or
(2) present the suggested edits to an administrator, receiving a selection, and automatically integrating the selection into the text.

7. The system of claim 6, wherein the processor is configured to perform (1).

8. The system of claim 6, wherein the processor is configured to perform (2).

9. The system of claim 6, wherein being configured to compile the suggested edits includes determining a count for each suggestion indicating a number of users who marked the respective suggested edit.

10. The system of claim 9, wherein being configured to present the suggested edits includes ordering the suggested edits according to their respective counts.

11. A non-transitory computer-readable storage medium encoded with instructions configured to be executed by a processor, the instructions which, when executed by the processor, cause the performance of a method, comprising:
receiving, with an electronic processor, text from a publisher user;
publishing, with the electronic processor, the text over a network accessible by a plurality of users;
providing tools for marking suggested edits to each user;
receiving input from each user including suggested edits;
compiling the suggested edits; and either:
(1) automatically integrating an edit into the text conditioned on a plurality of similar suggested edits being greater than a threshold; or
(2) presenting the suggested edits to an administrator, receiving a selection, and automatically integrating the selection into the text.

12. The method of claim 11, wherein the method performs (1).

13. The method of claim 11, wherein the method performs (2).

14. The method of claim 11, wherein the compiling the suggested edits includes determining a count for each suggestion indicating a number of users who marked the respective suggested edit.

15. The method of claim 14, wherein the presenting includes ordering the suggested edits according to their respective counts.
